(19) United States
(12) Patent Application Publication
(10) Pub. No.: US 2026/0310754 A1
(43) Pub. Date: Oct. 8, 2026

(54) SYSTEMS AND METHODS FOR DEPOSITING AND IDENTIFYING PATTERNED COATINGS

(71) Applicant: Avery Dennison Corporation, Mentor, OH (US)

(72) Inventors: Paul G. BODAGER, Shaker Heights, OH (US); Christopher E. KOHLER, S. Williamsport, OH (US); Ranjit MALIK, Port Matilda, PA (US); Jarkko PITKO, Masala (FI); Radha SEN, Mentor, OH (US); Liviu DINESCU, Huntersville, NC (US)

(21) Appl. No.: 19/477,913

(22) PCT Filed: Jun. 18, 2024
(86) PCT No.: PCT/IB2024/055945

§ 371 Date: Oct. 23, 2025

Related U.S. Application Data
(60) Provisional application No. 63/509,557, filed on Jun. 22, 2023.

(51) Int. Cl. G06F 18/22; B05D 1/02; G06F 16/51; G06V 10/74

(52) U.S. Cl. CPC G06F 18/22; B05D 1/02; G06F 16/51; G06V 10/74

(57) ABSTRACT

This disclosure generally relates to adhesive films and laminates and methods for producing and using the same are described herein. Specifically, adhesive films and laminates and methods for producing the same including a unique patterned coating or adhesive identifier.

### CROSS-REFERENCE TO RELATED APPLICATION(S)

The present application claims priority to and the benefit of U.S. Provisional Patent Application No. 63/509,557, filed Jun. 22, 2023, the entirety of which is incorporated herein by reference in its entirety.

### TECHNICAL FIELD

This disclosure generally relates to adhesive films and laminates and methods for producing and using the same are described herein. Specifically, adhesive films and laminates and methods for producing the same including a unique patterned coating or adhesive identifier.

### BACKGROUND

Laminates are known in the art. Such products are provided in a variety of forms including, for example, tapes, sheets, and labels. Although satisfactory in many respects, a new class of laminates is needed which provide one or more functionalities, and which can be produced in a cost-efficient manner.

A variety of techniques are known for applying a coating or an adhesive to a face material. Methods are also known in which a coating or an adhesive is coated on a secondary material which is then combined with a face material. The coating or adhesive layer can be continuous or discontinuous. Discontinuous coating or adhesive layers typically include regular or uniform patterns or structures. Although such patterning may reduce the amount of adhesive used, the regular or uniform patterns or structures can have limitations, such as ungummed/uncoated edges of the label resulting in poor dispensing, flagging, poor print quality, and/or poor die-cutting. Although satisfactory in many respects, a need remains for additional strategies for depositing coating or adhesive on face materials in which particular properties and/or characteristics of the resulting structure can be maintained or improved.

Additionally, a need exists for materials with additional information, in a smaller area. This can promote sustainability as a way of reducing the area required to adequately convey information.

### SUMMARY

Exemplary embodiments relate to a method comprising: applying a coating in a pattern to at least one component of a laminate; exposing the coating pattern; recording the pattern of the coating; and creating a data bearing record containing the pattern of the coating. This embodiment or another exemplary embodiment provide a release liner defining a release face and an oppositely directed outer face. This embodiment or another exemplary embodiment provide a face material defining an inner face and an oppositely directed outer face; and concurrently passing both the coating containing release liner and the face material through a nip region defined between at least one roller of a roller assembly, wherein at least a portion of the coating is contacted with the inner face of the face material to thereby form the laminate. This embodiment or another exemplary embodiment provide the pattern of the coating is discontinuous and irregular. This embodiment or another exemplary embodiment provide the pattern of the coating has a coverage over the area of the component of the laminate greater than about 5% and less than about 75%. This embodiment or another exemplary embodiment provide the coating is applied via spray coating. This embodiment or another exemplary embodiment provide laminating an optically transparent layer over the coating pattern. This embodiment or another exemplary embodiment provide applying the coating is done on top of a laminate structure. This embodiment or another exemplary embodiment provide laminating a layer comprising near-infrared (NIR) ink to the top of the laminate structure, and applying the patterned coating to at least a portion of a top of this layer. This embodiment or another exemplary embodiment provide the exposing step comprises removing at least a portion of at least one layer of the laminate.

Another exemplary embodiment relates to a method comprising: processing a provided image of a patterned coating on a laminate; analyzing the provided image against a database of recorded coating patterns; matching the provided image with an entry in the database; and providing a response corresponding to the entry. This embodiment or another exemplary embodiment provide the laminate is multilayered, and the patterned coating is longitudinally under at least one layer of the laminate. This embodiment or another exemplary embodiment provide the patterned coating is located on top of the laminate. This embodiment or another exemplary embodiment provide the pattern of the coating is discontinuous and irregular. This embodiment or another exemplary embodiment provide the pattern of the coating has a coverage over the area of at least one layer of the laminate greater than about 5% and less than about 75%.

Yet another exemplary embodiment relates to a system comprising: at least one detector; at least one processor; and at least one memory unit; and wherein the at least one detector is operative to image a patterned coating on a laminate, the at least one processor is operative to identify features of the patterned coating, and the at least one memory unit is operative to store the image and its identified features. This embodiment or another exemplary embodiment provide the patterned coating is applied via spray coating. This embodiment or another exemplary embodiment provide at least one coating unit operative to deposit the patterned coating; and at least one lamination unit operative to combine one or more layers of a laminate. This embodiment or another exemplary embodiment provide at least one ink unit, wherein the ink unit is operative to deposit near-infrared (NIR) ink to the top of the laminate. This embodiment or another exemplary embodiment provide the pattern of the coating is discontinuous and irregular.

### BRIEF DESCRIPTION OF THE DRAWINGS

FIG. 1 is a cross sectional schematic illustration of a coating or adhesive region on a substrate in accordance with the present subject matter.

FIG. 2 is a cross sectional schematic illustration of a plurality of coating or adhesive regions on a substrate in accordance with the present subject matter.

FIG. 3 is a planar illustration of an exemplary implementation of a label with coatings as discussed herein.

FIG. 4 is a cross sectional schematic illustration along line 4-4 of FIG. 3 of an exemplary implementation of a label.

FIG. 5 is a planar illustration of another exemplary implementation of a label with coatings as discussed herein.

FIG. 6 is a cross sectional schematic illustration along line 6-6 of FIG. 5 of an exemplary implementation of a label with depositor nozzles active and inactive.

FIG. 7 is a planar illustration of yet another exemplary implementation of a label with coatings as discussed herein.

FIG. 8 is a cross sectional schematic illustration along line 8-8 of FIG. 7 of an exemplary implementation of a label with a depositor nozzle active.

FIG. 9 is a planar illustration of another exemplary implementation of a label with coatings as discussed herein.

FIG. 10 is a cross sectional schematic illustration along line 11-11 of FIG. 10 of an exemplary implementation of a label in accordance with an embodiment.

FIG. 11 is a cross sectional schematic illustration along line 11-11 of FIG. 10 of an exemplary implementation of a laminated label in accordance with an embodiment.

FIG. 12 is a planar illustration of yet another exemplary implementation of a label with coatings as discussed herein.

FIG. 13 is a cross sectional schematic illustration along line 13-13 of FIG. 12 of an exemplary implementation of a label in accordance with an embodiment.

FIG. 14 is a cross sectional schematic illustration along line 13-13 of FIG. 12 of an exemplary implementation of a laminated label in accordance with an embodiment.

FIG. 15 is a planar illustration of yet another exemplary implementation of a label with coatings as discussed herein.

FIG. 16 is a cross sectional schematic illustration along line 16-16 of FIG. 15 of an exemplary implementation of a laminated label in accordance with an embodiment.

FIG. 17 is a planar illustration of yet another exemplary implementation of a label with coatings as discussed herein.

FIG. 18 is a planar illustration of yet another exemplary implementation of a label with coatings as discussed herein under NIR light.

FIG. 19 is a cross sectional schematic illustration along line 19-19 of FIG. 17 of an exemplary implementation of a label in accordance with an embodiment.

FIG. 20 is a cross sectional schematic illustration under NIR light along line 20-20 of FIG. 18 of an exemplary implementation of a label in accordance with an embodiment.

FIG. 21 is a schematic illustration of a system and process in accordance with an embodiment of the present disclosure.

FIG. 22 is a schematic illustration of a system and process in accordance with another embodiment of the present disclosure.

FIG. 23 is a is a schematic illustration of a system in accordance with another aspect of the present subject disclosure.

### DEFINITIONS

As used herein, “regular pattern” means the evenness, consistency, and/or balance in shape, arrangement, and/or pattern orientation variation and homogeneity that is repeating.

As used herein, “irregular pattern” or “random pattern” means not even or balanced in shape, arrangement, and/or pattern orientation variation and heterogeneity that is non-repeating.

As used herein, “repeat pattern” means the pattern of adhesive is regular in terms of shape, arrangement and/or pattern orientation and heterogeneity is repeating.

As used herein, “discontinuous” means that one or more regions, portions, parts, or spaces of the liner is not covered by coating or adhesive.

As used herein, “continuous” means that all of one surface of the liner is covered by the coating or adhesive at some level.

As used herein “optically transparent” or “optically translucent” can refer to a property of a material that refers to the ability of the material to allow part of the electromagnetic spectrum (e.g. light waves) to pass through, specifically in the visible spectrum with wavelengths of about 380 nanometers to about 750 nanometers. “Optically transparent” as used herein refers to any material that does not have 100% impendence of electromagnetic energy (e.g. light waves). An optically transparent material can allow 1% to 100% of all light waves or other electromagnetic energy to pass through.

As used herein, “exposed” or “exposing” refers to the state of a material not covered or otherwise obstructed by a layer of material, or if there is a physical covering of material, that material is optically transparent. In short, “exposed” refers to the fact that there is no obstacle or barrier for a sensor or other optical unit to detect the material described in such a way.

As used herein, the term “laminate” means, with respect to construction, at least one adhesive coated material, generally with one or more additional layers. Non-limiting examples of such layers to make up the multilayer include protective layers, spacing layers, adhesive layers, optical component-containing layers, metallic layers, barrier layers, release liners, tie coat layers, clear layers, color layers, white layers, reflective layers, fluid transfer layers, strength promoting layers, topcoats, print receptive layers, print containing layers, indicia layers, functional layers, and the like as well as combinations thereof. The resultant multilayer laminate construction described herein can be used for a variety of applications including, but not limited to, graphics applications, such as automobile and architectural wraps; reflective applications, such as road and traffic signs, trains and other commercial vehicles, etc.; and label and packaging applications.

“Feature Width” as used herein means the average width distance of a coating or adhesive region disposed on a face material and measured in a cross direction relative to the direction of processing of the face material.

“Feature Height” as used herein means the average thickness of the same coating or adhesive region disposed on a face material and measured in a direction transverse to the plane of the face material.

### DETAILED DESCRIPTION

Exemplary embodiments herein are directed towards methods and systems using a coating or adhesive pattern for identification purposes.

### Adhesives

The laminates/constructs described herein contain one or more adhesives. The adhesive(s) can be a PSA, a non-pressure sensitive adhesive, a hot-melt adhesive, or combinations thereof. In some embodiments, the adhesive is a PSA. The PSA may be any known PSA. In some embodiments, the PSA is a solvent type adhesive, an emulsion type adhesive, or non-emulsion type adhesive. In some embodiments, the PSA is an emulsion adhesive. Hot melt PSAs may also be used. The adhesive may be acrylic or any other useful adhesive which has the hardness and adhesive properties needed for the laminates and/or adhesive coated facestocks. In certain embodiments, the adhesive should have a hardness sufficient to prevent the adhesive squeezing out of the laminate or article during processing.

Exemplary PSAs may be found in (1) Encyclopedia of Polymer Science and Engineering, Vol. 13, Wiley-Interscience Publishers (NewYork, 1988); (2) Polymer Science and Technology, Vol. 1, Interscience Publishers (New York, 1964); (3) those described in U.S. Pat. Nos. 5,164,444; 5,183,459; and 5,264,532, all issued to Bernard, and U.S. Pat. No. 5,385,965, issued to Bernard et al; and (4) combinations thereof. The PSAs may be a solvent based or may be a water based adhesive. Conventional PSAs, including acrylic-based PSAs, rubber-based PSAs and silicone-based PSAs may be used in the laminates/constructs described herein. In one embodiment, the pressure sensitive adhesive contains an acrylic emulsion adhesive.

In some embodiments, the pressure sensitive adhesive is prepared by polymerizing alkyl acrylates, vinyl esters, diesters of dicarboxylic acids and unsaturated acids. The alkyl acrylates typically contain from about 2 to about 12, or from about 4 to about 8 carbon atoms in the alkyl group. Examples of alkyl acrylates include, but are not limited to, ethyl, n-butyl, hexyl, 2-ethylhexyl, and isooctyl acrylates, with 2-ethylhexyl acrylate preferred. In one embodiment, the alkyl acrylates are present in an amount of at least about 35%. In some embodiments, the alkyl acrylates are present in an amount from about 35% to about 60% by weight.

The vinyl esters typically have from about 2 to about 12, or from about 4 to about 8 carbon atoms in the alkyl group. Examples of vinyl esters include, but are not limited to, vinyl acetate, vinyl propionate, vinyl butyrate, vinyl versatate and the like, with vinyl acetate being preferred. In some embodiments, the vinyl esters are present in an amount from about 15% to about 35% or from about 20% to about 25% by weight.

The diesters of the dicarboxylic acids include alkyl esters of unsaturated diacids, such as maleic acid or anhydride and fumaric acids. The alkyl group generally contains from about 2 to about 20, or from about 4 to about 16, or from about 6 to about 12 carbon atoms. Examples of diesters of diacids include, but are not limited to, butyl, octyl fumarate; hexyl, decyl maleate; di-2-ethylhexyl maleate; di-butyl fumarate; and di-2-ethylhexyl fumarate and mixtures thereof. In some embodiments, the diesters of diacids are present in an amount from about 20% to about 35% by weight.

The unsaturated acids generally contain from about 2 to about 12, or from about 2 to about 6 carbon atoms. Examples of the unsaturated acids include, but are not limited to, acrylic acid, methacrylic acid, itaconic acid, and the like. In some embodiments, the unsaturated acids are present in an amount up to 5% or from about 1% to about 3% by weight.

In exemplary embodiments, the coat weight of adhesives may be between 2 and 100 gsm.

### Release Liners

In some embodiments, the laminates described herein may include one or more release liner(s). The liner may have a first side, a second side opposed to the first side, a first edge, and a second edge opposed to the second edge. The liner may be any useful liner which provides necessary support and release properties. The liner may be made of, or from, a variety of materials including, but not limited to, paper or polymer film liners. In one embodiment, the caliper of the paper is sufficient to die cut the resulting laminate or article. For example, liner calipers can range from about 18 mm to 23 mm for PET liners. In one embodiment, the liner has lay flat properties. In some embodiments, the liner has a machine glaze or finish. In some embodiments, the liner has a silicone hold out layer. The hold out layer provides adhesion between the release coating and the release liner. The silicone holdout layer also prevents the silicone release coating from soaking into the liner.

In some embodiments, the release liner includes a liner having a release coating. The release coating of the release liner provides a releasable bond with the PSA or other adhesive. The release coating may be any composition which provides a desired releasable bond strength.

In one embodiment, the release coating is a silicone release coating. The release coating can be prepared by curing silicone polymers in the presence of a control release agent. In some embodiments, the control release agent is a copolymer of a monofunctional silicone unit of the formula R₃SiO_{1/2} and tetrafunctional silicone units SiO_{4/2} wherein R is an alkyl or alkenyl group. In one embodiment, the alkyl or alkenyl groups contain from about 1 to about 12, or from about 1 to about 6 carbon atoms. Non-limiting examples of alkyl and alkenyl groups include methyl, ethyl, propyl, butyl, hexyl, ethenyl, propenyl, butenyl and hexenyl groups.

The control release agent is typically reacted with a polysiloxane. The polysiloxane may be any polysiloxane which is useful in forming a release coating.

Examples of useful polysiloxanes include, but are not limited to, vinyl terminated, hydroxy terminated and epoxy terminated polysiloxanes. In one embodiment, the polysiloxane is a functional polydialkyl siloxane, wherein the alkyl group contains from about 1 to about 6 carbon atoms. The alkyl groups independently include, but are not limited to, methyl, ethyl, propyl, butyl, pentyl, hexyl groups or mixtures thereof. In one embodiment, the alkyl or alkenyl group contains from 1 to about 12, or from 1 to about 6 carbon atoms. The polysiloxane typically has a viscosity average molecular weight of greater than 300,000 centipoise (cps). In another embodiment, the polysiloxane has a viscosity molecular weight from about 300,000 to about 1,000,000 or more. The polysiloxane may be represented by the formula (I):

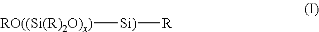

wherein each R is independently as defined above and x is an integer.

In some embodiments, the release coating is prepared with a cross linking agent. In some embodiments, the cross linking agent is a reactive polysiloxane, such as a polydialkyl or polyhydroalkyl siloxane. The alkyl groups are the same as those described above.

The release coating may be applied in a solvent, solvent-less or emulsion form. The release coating may be cured by any known curing process, e.g. thermal, radiation, etc., to form the release coating. The curing may be catalyzed by silicone soluble complexed compounds of Group VIII transition metals, such as platinum.

Commercially available release agents include, but are not limited to, GE SS-4335, a silicone release agent in unreactive solvent. Commercially available polysiloxanes include, but are not limited to, GE SS-4331, a vinyl terminated polydimethyl siloxane. Commercially available linking agents include, but are not limited to, GE SS-4300C, a polymethyvinyl siloxane. Exemplary catalysts include, but are not limited to, SS-8010 catalyst in toluene. These materials are available commercially from General Electric Company's Silicone Products Division. Similar silicone products are available under the tradename Syl-off from Dow Corning Corporation.

It will be understood that the present subject matter is not limited to any of the noted release coatings or agents, and instead includes nearly any release coating or agent suitable for the intended end use application. Furthermore, although the present subject matter has been described in association with release liners, it will be appreciated that appropriately configured carrier films and other members could be used instead of release liners.

### Face Material

Suitable face materials include, but are not limited to, synthetic papers such as polyolefin type and polystyrene type; various plastic films or sheets such as polyolefin, polyvinyl chloride, polyethylene terephthalate, polystyrene, polyurethane, polymethacrylate and polycarbonate. Additional examples of suitable face materials include paper and cardboard. The face material may be, or may include, a multilayer polymeric sheet. The multi-layers may be coextruded, or the multi-layers may be laminated together. In one embodiment, the face material includes both co-extruded multi-layers and laminated multi-layers. In addition, a white opaque film may be formed by adding a white pigment to one or more of the aforementioned synthetic resins and used as the face material. In one embodiment, a foamed film is used as the face material. The foamed film may be formed by a conventional foaming operation. In another embodiment, the face material may be a laminated body formed by combining a plurality of single layered sheets composed of the above listed materials. Examples of such a laminated body may include the combination of cellulose fiber paper with synthetic paper, and a laminated body of combined cellulose fiber paper with a plastic film or sheet. In another suitable embodiment, the face material includes coated and uncoated papers, metalized papers, aluminum foil, laminated paper and paper with a polymeric material extruded onto the surface of the paper. In certain versions, the face material can be coated with a liquid absorbent material. The selected face material may be porous or semi-porous. The face material may exhibit certain visibility characteristics such as opaqueness, color, and/or brightness. The face material may include water or other liquid absorbency properties. The face material may be electrically conductive and/or include electrically conductive coatings or regions. A wide array of commercially available face materials can be used such as for example those available under the designation TESLIN.

The thickness of the face material is optionally determined with reference to application specific criteria. Such criteria may include the desired end use. In one embodiment, the sheet thickness is in a range of from about 10 μm to about 300 μm. In another embodiment, the sheet thickness is in a range of from about 20 μm to about 200 μm. In still another embodiment, the sheet thickness is in a range of from about 30 μm to about 150 μm. Optionally, a primer treatment or a corona discharging treatment or a plasma treatment may be used on the face material to increase a bonding strength between the face material and a dried topcoat composition to be formed on a surface of the face material.

In certain embodiments described herein, the face material exhibits one or more functions or functional characteristics. For example, the face material may be selected to enable or promote an indication such as a visual indication of a liquid, outgassing such as directing or allowing flow of air or gas across a thickness of the face material, water or liquid retention within the face material, electrical discharge or conductivity of the face material, chemical delivery across a thickness of the face material, passage of sound across a thickness of the face material, and/or combinations of these functions or characteristics.

### Optional Layers

The adhesive coated face material and/or laminates described herein can include one or more additional layers or components. Non-limiting examples of such layers include protective layers, tie coat layers, clear layers, color layers, white layers, reflective layers, fluid transfer layers, strength promoting layers, topcoats, print receptive layers, print containing layers, indicia layers, functional layers, and the like.

### Laminate Properties

The laminates described herein may have specific and useful properties or functionalities. In some embodiments, the techniques described herein enable formation of laminates in which transfer, propagation, and/or migration of liquid, gas, sound waves, electrical current, and/or other agents or elements can occur and is controlled across or through the laminate in a Z-direction. The reference to “Z-direction” as made herein refers to a direction across a thickness dimension of a laminate or portion thereof, and thus references to “X-direction” and/or “Y-direction” refer to directions perpendicular to the Z-direction and correspond to width and length dimensions of the laminate.

Non-limiting representative examples of laminates having certain functionalities which are provided by the present subject matter include liquid indicator laminates, outgassing laminates, water absorbent laminates, sound channeling laminates, electrically conductive laminates, and laminates having combinations of these functionalities and/or laminates having combinations of one or more of these functionalities and additional functionalities.

For example, a liquid indicator laminate can be produced such that the speed of the indicator color change is linked to the facestock selection and porous adhesive properties. A discontinuous structure, such as resulting from pores in the adhesive layer or region(s), can allow, for example, liquid to channel through the discontinuous adhesive from one side of the adhesive to the other side and create a permanent discoloration when a dye or other agent in a functional coating in the laminate is dissolved.

In one embodiment, a liquid indicator laminate is provided. The speed or rate of the indicator color change is linked to the facestock properties such as for example absorbency of liquid, and porosity of the pattern adhesive in the Z-direction. The indication typically is irreversible and can be measured by color change or by a simple visual comparison.

The discoloration of a face or region of the laminate can be measured and quantified by optical change, such as by CIE Lab or by a simple visual comparison. The discoloration can be permanent or nonpermanent. The discoloration can also be temporary and revert to an initial state after passage of a period of time. In some embodiments, the period of time is predetermined.

This phenomenon of transport through discontinuities in an adhesive in the Z-direction can be implemented in other label applications and particularly pressure sensitive adhesive labels, such as for example, labels for outgassing substrates such as by air channeling in the Z-direction, moist substrate labeling such as by liquid channeling in the Z-direction, electrical discharge in the Z-direction, chemical delivery from one layer to another in the Z-direction, and/or sound channeling in the Z-direction. This phenomenon enables passage, transfer, and/or migration of a medium or agent from one side of an adhesive region of a laminate, to another side of the adhesive region. Although medium penetration or transport is noted as being in the Z-direction, it will be understood that the present subject matter is not limited to such and may also include penetration/transport in the X-direction and/or Y-direction.

In some embodiments, the laminates described herein include a layer or region of a secondary adhesive. The secondary adhesive is typically utilized to adhere the laminate to a substrate of interest. The secondary adhesive may contain one or more adhesives which are the same or different than the adhesive of the patterned or porous adhesive. Description of representative examples of secondary adhesives are provided herein. In such an adhesive configuration, the primary adhesive may be coated onto the facestock, the secondary adhesive may be coated onto the release liner, and the coated adhesive and release liner may be laminated together such that the primary and secondary adhesives are in direct contact with each other. Alternatively, or additionally, both the primary and secondary adhesive may be coated on the facestock or the release liner, then laminated together. It is contemplated that the layering of the primary and secondary adhesive relative to the facestock and the release liner may be either facestock, primary adhesive, secondary adhesive, and release liner or facestock, secondary adhesive, primary adhesive, release liner. Regardless of the order of primary and secondary adhesive, it is contemplated that at least one of the primary and secondary adhesive is patterned, taking into consideration that the other adhesive may be continuous.

In some embodiments, an array of different arrangements of layers and components may be utilized. In some embodiments using the patterned adhesive, e.g., the layer of discontinuous adhesive, that layer is disposed between a functional facestock and a liner or functional layer. And in the liquid indicator laminates, the patterned adhesive may be disposed between the functional facestock and the layer or region of functional agent that is sensitive to liquid passing through the laminate. And, in the liquid indicator laminates, the layer or region of the functional agent may be disposed between the patterned adhesive and the carrier layer.

Utilization of the techniques and features described herein enable production of adhesive laminates and/or adhesive coated face materials with fluid/air management characteristics, controlled removability, and/or unique thermal and/or electrical conductivity. In addition, use of these techniques and features enable reductions in materials, e.g., adhesives, and thus enable cost savings. However, it will be understood that the present subject matter includes the adhesive coated face materials and laminates described herein which are formed by other methods than the methods described herein.

### Top Coat Formulation and Application

In exemplary embodiments discussed herein, the top coat coating is deposited on the substrate by any suitable method. In embodiments, the suitable method includes any suitable coating technology. Embodiments include depositing the coating on the substrate by any suitable liquid deposition method. Without limitation, examples of suitable methods include bath coating, spray coating, slot coating, spin coating, curtain coating, gravure coating, reverse gravure print coating, reverse roll coating, knife over roll (i.e., gap) coating, metering (Meyer) rod coating, air knife coating, or any combinations thereof. Bath coating includes immersion or dip in the aqueous solution. In an embodiment, the coating is deposited by bath in the aqueous solution. In other embodiments, the coating is deposited by spray of the aqueous solution.

Adhesive and/or Coating Patterns

Adhesive or coating region(s) and/or coating or adhesive structures disposed on substrates are described herein. In some embodiments, the coating or adhesive region(s) and/or structures exhibit particular dimensional proportions as described herein. In some embodiments, the adhesive is a pressure sensitive adhesive (PSA). The PSA can be applied using a variety of techniques, such as spraying, onto a face material, e.g., release liner or face stock. In other embodiments the coating is a hot melt compound that when room temperature is no longer tacky to the touch. Once applied, the coating or PSA may optionally be cured and/or otherwise processed. In some embodiments, the release liner and coating or PSA deposited thereon are then contacted with a face material, such as label stock or a polymeric film, thereby at least partially transferring the coating or PSA to the face material. The release liner may be removed at a later time to expose the coating or PSA face and enable the user to adhere the face material to a substrate of interest. In other embodiments, the face stock (e.g., label stock or a polymeric film) and coating or PSA deposited thereon are then contacted with a release liner. The release liner may be removed at a later time to expose the coating or PSA face and enable the user to adhere the face material to a substrate of interest.

By use of these structures, assemblies, and/or techniques a variety of coating or PSA properties and deposition configurations are now attainable, which were not possible before using conventional methods of depositing coating or PSA onto face materials.

In some embodiments, the resulting thickness(es) of the coating or adhesive region(s) on the face material is within a range of from about 0.1 μm to about 10,000 μm, from about 0.5 μm to about 5,000 μm, from about 1 μm to about 1,000 μm, from about 3 μm to about 500 μm, or from about 5 μm to about 250 μm.

In particular embodiments, the coating or adhesive is deposited on the face material so as to form raised regions or features having particular dimensional proportions. These dimensional proportions can be quantified and are expressed herein as a Critical Dimensional Ratio (CDR) as defined in formula (II):

$$\frac{Feature Width}{Feature Height} \qquad ( II )$$

A variety of useful characteristics and beneficial properties of coating or adhesive laminates and coating or adhesive coated face materials are attainable if the coating or adhesive is deposited as described herein and/or transferred to a face material as described herein so that the resulting coating or adhesive regions on the face material exhibit Critical Dimensional Ratios (CDR's) of less than about 50, less than about 45, less than about 40, less than about 35, or less than about 30. Typically, a minimum CDR is about 1. In many embodiments, the coating or adhesive region(s) exhibit a CDR from about 1 to about 10.

In some embodiments, the coating or adhesive is deposited or formed in a pattern or non-uniform layer or region. In some embodiments, the coating or adhesive is in the form of a plurality of coating or adhesive regions separated from one another along a face of the face material, facestock, or substrate. When such patterned coating or adhesive layers or regions are incorporated in a laminate as described in greater detail herein, the voids or spaces between coating or adhesive regions are similar in certain aspects to pores or hollow voids. These pores or voids can be utilized in a wide array of functional laminates described in greater detail herein.

Adhesive coating or coated laminates and/or coating or adhesive coated face materials, particularly those produced using the methods described herein, and more specifically by roll to roll coating of coating or adhesive onto a face layer of the laminate, are also described. Many of these laminates can be configured to provide one or more functions as detailed herein. It will however be understood that the present subject matter includes laminates as described herein, yet which may be produced by techniques other than the unique methods described herein.

In some embodiments, there is use of a patterned coating. Specifically, these coatings can be adhesives, or non-adhesives. In the instance in certain embodiments that the patterned coating is on top, or not covered up, of a laminate structure, the coating can no longer be sticky or tacky. This may occur through either deactivation of the adhesive, or that the coating is not sticky or tacky. The coating, if not an adhesive may be any flowable material at temperatures above operating temperature and solid without being tacky at or below operating temperatures. In exemplary embodiments, operating temperatures may be between about 0° C. and about 40° C.

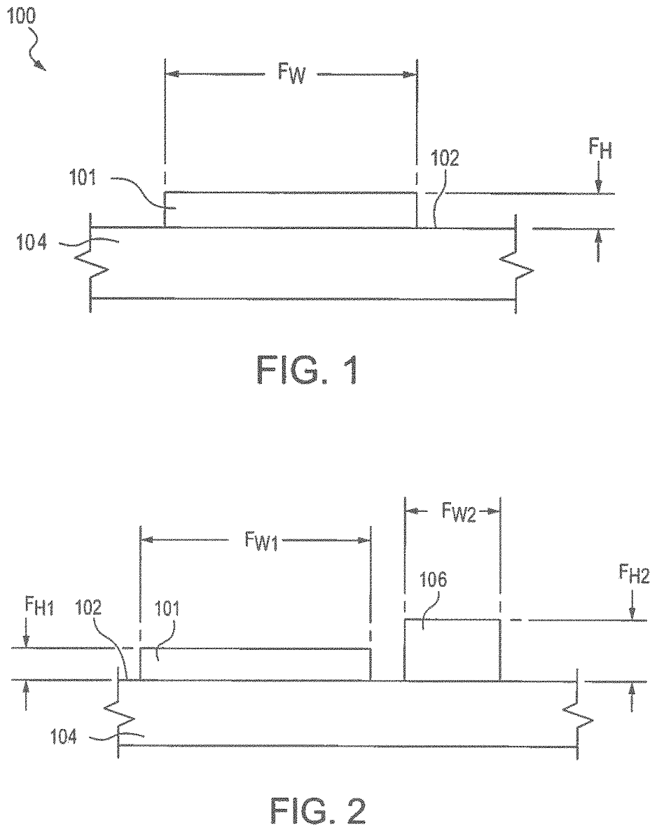

FIG. 1 is a cross sectional schematic illustration of a coating or adhesive region on a coating or substrate as described herein. Specifically, FIG. 1 illustrates an assembly 100 containing a coating or adhesive region 101 disposed on a face 102 of a face material 104 or other substrate. The adhesion region exhibits an average width distance FW and an average thickness or height of FH. In many embodiments the CDR of a coating or adhesive region 101 is within a range of from 1 to 50.

The laminates or constructs described herein may have coating or adhesive regions having different dimensions and proportions. For example, FIG. 2 is a cross sectional schematic illustration of a first coating or adhesive region 101 and a second a coating or coating or adhesive region 106 disposed on a face 102 of a face material 104 or other substrate. The first coating or adhesive region 101 exhibits an average width distance FW1 and an average thickness or height of FH1. The second coating or adhesive region 106 exhibits an average width distance FW2 and an average thickness or height of FH2. These thicknesses may be different or the same, and these heights may be different or the same. In many embodiments, coating or adhesive regions 101 and/or 106 exhibit CDRs within a range of from 1 to 50. The CDR of region 106 may be the same or different than the CDR of region 101.

In one embodiment, the coating or adhesive pattern serves as an identification structure or identification element. This occurs through exposing the coating or adhesive within a laminate structure including a plurality of layers stacked together/held together by a suitable means. In some embodiments, the plurality of layers includes a top layer and one more layers underlying the top layer. In an exemplary embodiment, the top layer is directly secured to the one or more underlying layers using a functional adhesive. In other embodiments, the top layer may be separated from the underlying layers by a waterproof layer or a waterproof coating. In some embodiments, each of the identification elements is selectively positioned across different layers of the plurality of layers of the identification structure for carrying out their respective functions and for additionally contributing to detection/identification of any unauthorized intervention. In one embodiment, one or more optical elements and one or more physical elements may be disposed in proximity to each other on a top layer of the identification structure. In some embodiments, the layers containing the two or more identification elements are adhesively secured to one another, and a release liner is provided underlying the upper layers of the identification structure.

In one embodiment, the one or more optical elements are, or may include or contain, symbols or patterns adapted to be scanned by an optical scanning device (e.g., machine readable elements or human readable elements). Examples include, but are not limited to, quick response code (QR code), a bar code (e.g., 2D bar code), surface texture, color, hologram, encapsulated ink and indicia, and combinations thereof. The optical elements serve as authentication members for enabling consumers to identify if the products to which the identification structure is secured are genuine or authentic. In one embodiment, the one or more optical elements are provided on the top layer of the identification structure.

### Inks

Within exemplary embodiments, there is an ink or print layer. This ink layer can be an ink or graphics layer, and the print layer may be a mono-colored or multi-colored print layer depending on the printed message and/or the intended pictorial design. These include variable imprinted data such as serial numbers, bar codes, trademarks, etc. The thickness of the print layer is typically in the range of about 0.5 to about 10 microns, and in one embodiment about 1 to about 5 microns, and in another embodiment about 3 microns. The inks used in the print layer include commercially available water-based, solvent-based, or radiation-curable inks. Examples of these inks include Sun Sheen (a product of Sun Chemical identified as an alcohol dilutable polyamide ink), Suntex M P (a product of Sun Chemical identified as a solvent-based ink formulated for surface printing acrylic coated substrates, PVDC coated substrates and polyolefin films), X-Cel (a product of Water Ink Technologies identified as a water-based film ink for printing film substrates), Uvilith AR-109 Rubine Red (a product of Daw Ink identified as a UV ink) and CLA91598F (a product of Sun Chemical identified as a multibond black solvent-based ink), Lexmark laser printer or toner inks, and Xerox laser printer or toner inks.

In one embodiment, the print layer comprises a polyester/vinyl ink, a polyamide ink, an acrylic ink and/or a polyester ink. The print layer may be formed in the conventional manner by, for example, gravure, fiexographic or UV flexographic printing or the like, an ink composition comprising a resin, a suitable pigment or dye and one or more suitable volatile solvents onto one or more desired areas of the film. After application of the ink composition, the volatile solvent component(s) of the ink composition evaporate(s), leaving only the non-volatile ink components to form the print layer.

The adhesion of the ink to the surface of the polymeric film can be improved, if necessary, by techniques well known to those skilled in the art. For example, as mentioned above, an ink primer or other ink adhesion promoter can be applied to the polymeric film layer or other underlying layer before application of the ink. Alternatively, the surface of the polymeric film can be corona treated or flame treated to improve the adhesion of the ink to the polymeric film layer.

Useful ink primers may be transparent or opaque and the primers may be solvent based or water-based. In one embodiment, the primers are radiation curable (e.g., UV). The ink primer may comprise a lacquer and a diluent. The lacquer may be comprised of one or more polyolefins, polyamides, polyesters, polyester copolymers, polyurethanes, polysulfones, polyvinylidine chloride, styrene-maleic anhydride copolymers, styrene-acrylonitrile copolymers, ionomers based on sodium or zinc salts or ethylene methacrylic acid, polymethyl methacrylates, acrylic polymers and copolymers, polycarbonates, polyacryionitriles, ethylene-vinyl acetate copolymers, and mixtures of two or more thereof. Examples of the diluents that can be used include alcohols such as ethanol, isopropanol and butanol; esters such as ethyl acetate, propyl acetate and butyl acetate; aromatic hydrocarbons such as toluene and xylene; ketones such as acetone and methyl ethyl ketone; aliphatic hydrocarbons such as heptane; and mixtures thereof. The ratio of lacquer to diluent is dependent on the viscosity required for application of the ink primer, the selection of such viscosity being within the skill of the art. The ink primer layer may have a thickness of from about 1 to about 4 microns or from about 1.5 to about 3 microns.

### Exemplary Laminate Structures

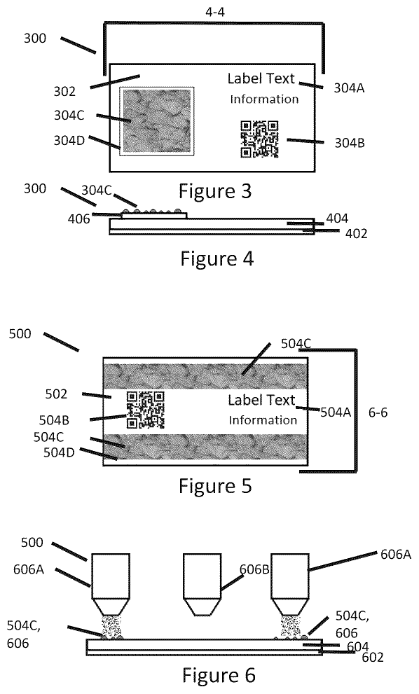

One such laminate structure envisioned in accordance with the disclosure is a label on label approach. This structure is shown on FIG. 3 and FIG. 4. Referring specifically to FIG. 3, a top planar view of such an exemplary construction is shown. A label 300 is shown with various components on a top face 302 of the label 300 including various identifying indicia 304A, 304B and 304C. In this embodiment, there is a place for text identifying information 304A, a QR code 304B, as well as a coating or adhesive component 304C. The coating or adhesive component 304C is optically isolated by virtue of an outer border 304D.

Referring specifically to FIG. 4, a cross-sectional view of the laminate structure of FIG. 3, along line 4-4 is shown. In this view, there is shown a longitudinal axis Y, a substrate layer 402, followed by a label stock 404, and then a secondary label 406 where the coating or adhesive component 304C is deposited. With the coating or adhesive component 304C deposited in this way, this allows for a three-dimensional touch and feel. Additional security features may be included and can include, but are not limited to, at least one taggant, metal flakes, or other detectable markers.

In another exemplary laminate structure, the pattern can be directly applied to the label structure. This structure is shown on FIG. 5 and FIG. 6. Referring specifically to FIG. 5, a top planar view of such an exemplary construction is shown. A label 500 is shown with various components on its top face 502, of the label 500 including various identifying indicia 504A, 504B and 504C. In this embodiment, there is a place for text identifying information 504A, a QR code 504B, as well as a coating or adhesive component 504C. The coating or adhesive component 504C is optically isolated by virtue of an outer border 504D.

Referring specifically to FIG. 6, a cross-sectional view of the laminate structure of FIG. 5, along line 6-6 is shown. In this view, there is shown a substrate layer 602, followed by a label stock 604, a coating or adhesive layer 606 where the coating or adhesive component 504C is deposited. With the coating or adhesive component 504C deposited in this way, this allows for a three-dimensional touch and feel. However, additional thermal printing or heat treatment is not possible after the coating or adhesive component 504C in this embodiment. Additional security features may be included and can include, but are not limited to, at least one taggant, metal flakes, or other detectable markers. As a result of active nozzle heads 606A, and inactive nozzle head 606B, these lanes of coating or adhesive 504C may be tailored and controlled. In this embodiment, or other exemplary embodiment the active nozzle heads may be connected to a heat source in order to heat them to allow the coating or adhesive to flow adequately. In exemplary embodiments the active nozzle heads may be heated between about 40° C. and about 150° C.

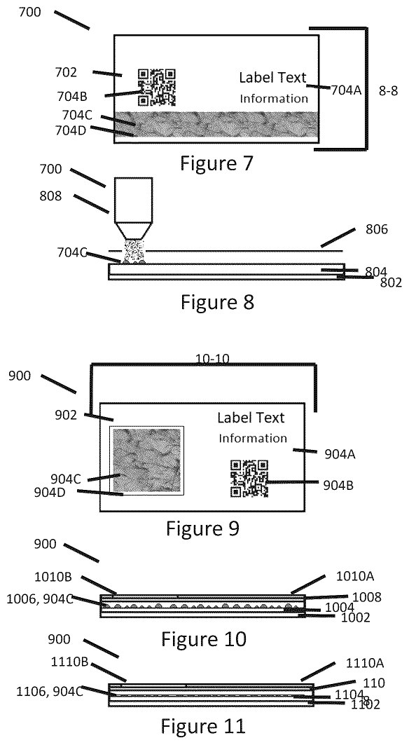

In another exemplary laminate structure, the pattern can be directly applied to the label structure with the presence of a mask. This structure is shown on FIG. 7 and FIG. 8. Referring specifically to FIG. 7, a top planar view of such an exemplary construction is shown. A label 700 is shown with various components on its top face 702, of the label 700 including various identifying indicia 704A, 704B and 704C. In this embodiment, there is a place for text identifying information 704A, a QR code 704B, as well as a coating or adhesive component 704C. The coating or adhesive component 704C is optically isolated by virtue of an outer border 704D.

Referring specifically to FIG. 8, a cross-sectional view of the laminate structure of FIG. 7, along line 8-8 is shown. In this view, there is shown a substrate layer 802, followed by a label stock 804, a coating or adhesive layer 806 where the adhesive component 704C is deposited and a mask layer 806 commiserate with the top face 702. The mask 806 allows for blocking the coating or adhesive 704C to focus on specific areas with an active nozzle head 808. A sharper and greater resolution along the lane edge is possible than using the nozzle 808 control alone. However, additional thermal printing or heat treatment is not possible after the coating or adhesive component 704C in this embodiment. Additional security features may be included and can include, but are not limited to, at least one taggant, metal flakes, or other detectable markers.

In another exemplary laminate structure, the pattern can be applied underneath a portion of the laminate structure. This structure is shown on FIG. 9, FIG. 10 and FIG. 11. Referring specifically to FIG. 9, a top planar view of such an exemplary construction is shown. A label 900 is shown with various components visible from its top face 902 of the label 900 including various identifying indicia 904A, 904B and 904C. In this embodiment, there is a place for text identifying information 904A, a QR code 904B, as well as a coating or adhesive component 904C. The coating or adhesive component 904C is optically isolated by virtue of an outer border 904D.

Referring specifically to FIG. 10, a cross-sectional view of the laminate structure of FIG. 9, along line 10-10 is shown. In this view, there is shown a substrate layer 1002, an adhesive substrate layer 1004 followed by a coating or secondary adhesive layer 1006 where the coating or adhesive component 904C, an optically clear layer 1008, and a mask layer 1010A with an optically clear window 1010B each the mask layer 1010A and optically clear window 1010B comprising the top face 902. Additional security features may be included and can include, but are not limited to, at least one taggant, metal flakes, or other detectable markers. The ultimate size and area covered by the optically clear window 1010B depends on the desired implementation.

Referring now specifically to FIG. 11, a cross-sectional view of an alternative to the structure of FIG. 9, taken along line 10-10 is shown. In this embodiment, the structure is similar to that of FIG. 9 and FIG. 10, with a shown a substrate layer 1102, an adhesive substrate layer 1104 followed by a coating or adhesive layer 1106 where the coating or adhesive layer is laminated and flattened within the structure, an optically clear layer 1108, and a mask layer 1110A with an optically clear window 1110B, each the mask layer 1110A and optically clear window 1110B comprising the top face 902. As a result of the flattening of the coating or adhesive layer, air trapping within the layer may be kept to a minimum. Additional security features may be included and can include, but are not limited to, at least one taggant, metal flakes, or other detectable markers. The ultimate size and area covered by the optically clear window 1110B depends on the desired implementation.

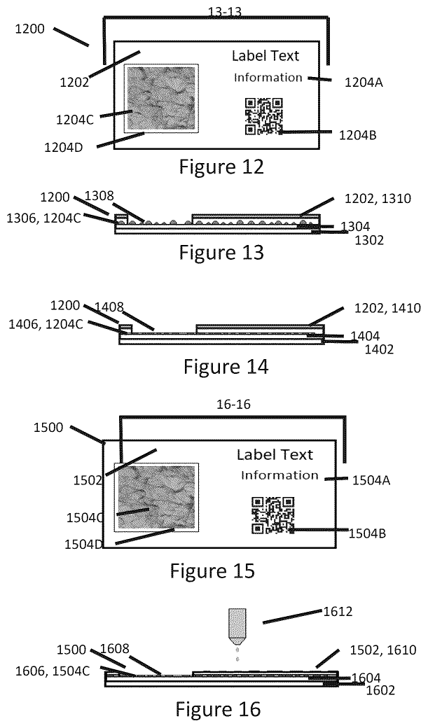

In another exemplary laminate structure, the pattern can be applied longitudinally underneath a portion of the laminate structure. This structure is shown on FIG. 12, FIG. 13 and FIG. 14. Referring specifically to FIG. 12, a top planar view of such an exemplary construction is shown. A label 1200 is shown with various components visible from its top face 1202 of the label 1200 including various identifying indicia 1204A, 1204B and 1204C. In this embodiment, there is a place for text identifying information 1204A, a QR code 1204B, as well as a coating or adhesive component 1204C. The adhesive component 1204C is optically isolated by virtue of an outer border 1204D.

Referring specifically to FIG. 13, a cross-sectional view of the laminate structure of FIG. 12, along line 13-13 is shown. In this view, there is shown a substrate layer 1302, a coating or adhesive substrate layer 1304 followed by an adhesive layer 1306 where the coating or adhesive component 1204C is deposited, a window cut out portion 1308, and a mask layer 1310 each of the window cut out layer 1308 and the mask layer 1310 comprising the top face 1202. Additional security features may be included and can include, but are not limited to, at least one taggant, metal flakes, or other detectable markers. The ultimate size and area covered by the window cut out portion 1308 depends on the desired implementation.

Referring now specifically to FIG. 14, a cross-sectional view of an alternative to the structure of FIG. 12, taken along line 14-14 is shown. In this embodiment, the structure is similar to that of FIG. 12 and FIG. 13, with a shown a substrate layer 1402, an adhesive substrate layer 1404 followed by a coating or adhesive layer 1406 where the adhesive layer is laminated within the structure, a window cut out portion 1408, and a mask layer 1410 comprising the top face 1402. Additional security features may be included and can include, but are not limited to, at least one taggant, metal flakes, or other detectable markers. The ultimate size and area covered by the window cut out portion 1408 depends on the desired implementation.

In another exemplary laminate structure, the pattern can be applied digitally and longitudinally underneath a portion of the laminate structure. This structure is shown on FIG. 15 and FIG. 16. Referring specifically to FIG. 15, a top planar view of such an exemplary construction is shown. A label 1500 is shown with various components visible from its top face 1502 of the label 1500 including various identifying indicia 1504A, 1504B and 1504C. In this embodiment, there is a place for text identifying information 1504A, a QR code 1504B, as well as a coating or adhesive component 1504C. The coating or adhesive component 1504C is optically isolated by virtue of an outer border 1504D.

Referring now specifically to FIG. 16, a cross-sectional view of the structure of FIG. 15 taken along line 15-15 is shown. In this embodiment shown is a substrate layer 1602, an adhesive substrate layer 1604 followed by a coating or adhesive layer 1606 where the coating or adhesive layer 1606 is laminated within the structure, with a window cut out portion 1608 and a top layer 1610. Additional security features may be included and can include, but are not limited to, at least one taggant, metal flakes, or other detectable markers. The coating, adhesive, or additional features could be placed by a depositor 1612. In an exemplary embodiment, the depositor is an inkjet printerhead. In one embodiment the ultimate size and area covered by the window cut out portion 1608 depends on the desired implementation.

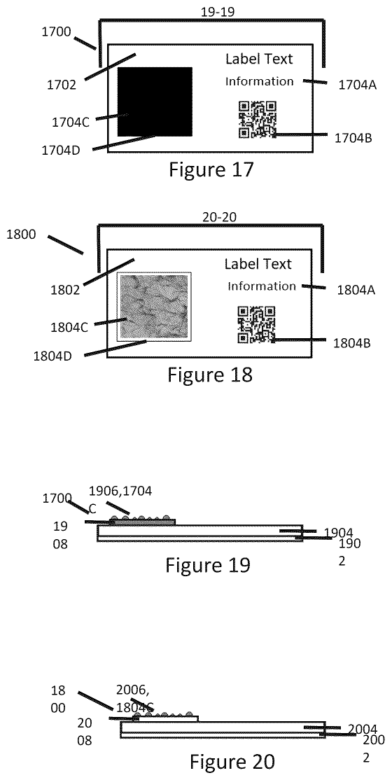

In another exemplary laminate structure, the pattern can be applied digitally and on top of the laminate structure with near infrared (NIR) inks. Such an exemplary structure is shown in FIG. 17, FIG. 18, FIG. 19, and FIG. 20. Referring specifically to FIG. 17, a top planar view of such an exemplary construction is shown. FIG. 17 is taken from the perspective of what one would see with the visible spectrum. A label 1700 is shown with various components visible from its top face 1702 of the label 1700 including various identifying indicia 1704A, 1704B and 1704C. In this embodiment, there is a place for text identifying information 1704A, a QR code 1704B, as well as an NIR embedded coating or adhesive component 1704C.

Referring specifically to FIG. 18, a top planar view of such the exemplary construction of FIG. 17 is shown taken from the perspective of what one would see with under NIR light. A label 1700 is shown with various components visible from its top face 1702 of the label 1700 including various identifying indicia 1704A, 1704B and 1704C. In this embodiment, there is a place for text identifying information 1704A, a QR code 1704B, as well as an NIR embedded coating or adhesive component 1704C which now allows for view of the optically isolated nature of the coating or adhesive component 1704C by virtue of an outer border 1704D, now distinguished by the NIR light.

Referring specifically to FIG. 19, a cross-sectional view of an alternative to the structure of FIG. 17 taken along line 19-19 is shown. In this embodiment shown is a substrate layer 1902, an NIR reflecting base layer 1904, a coating or adhesive layer 1906 and a label film base 1908. Additional security features may be included and can include, but are not limited to, at least one taggant, metal flakes, or other detectable markers. The coating or adhesive component 1906 can include a pigment opaque to both visible light as well as NIR. This can be in contrast to the label film base 1908 which can have NIR dye which is opaque in visible light spectrum while remaining transparent in NIR. Therefore, with this configuration, the base film becomes transparent while all identifying features are not. This concept is further illustrated in FIG. 20, as FIG. 20 is a cross section taken along line 20-20 in FIG. 18. As can be seen, FIG. 20 is shown taken from the perspective of what one would see with under NIR light. In this case, with a substrate layer 2002, an NIR reflecting base layer 2004, a coating or adhesive layer 2006 and a label film base 2008 only the coating or adhesive 2006 colored with a pigment absorbs the NIR light. In an exemplary embodiment, the pigment is based on carbon black.

In the instance of all of the above embodiments discussed, contrasting colors between the adhesive layer and the main label color is required. For example, if the coating or adhesive layer is underneath optically clear film, the adhesive layer may be pigmented black and the main label may be white. In other embodiments when NIR is being used, the NIR reflecting background can be white or can be metallic when contrasted with the pigmented adhesive.

In the instance where there is a window removed in order to expose the adhesive layer, this can be done by a laser or plotter type of mechanism, which will be discussed later with respect to operation and/or the system. Additionally, the adhesive may be limited to lanes of material. Such lanes can be controlled by turning on or off the nozzles associated with their location. Optical isolation and identification can be done via lane only, as will be discussed later with respect to operation. Additionally, further printing or processing will be discussed with respect to operation.

### Systems and Methods

Having discussed various components of the apparatus, exemplary systems, methods and methodologies of operation will be discussed.

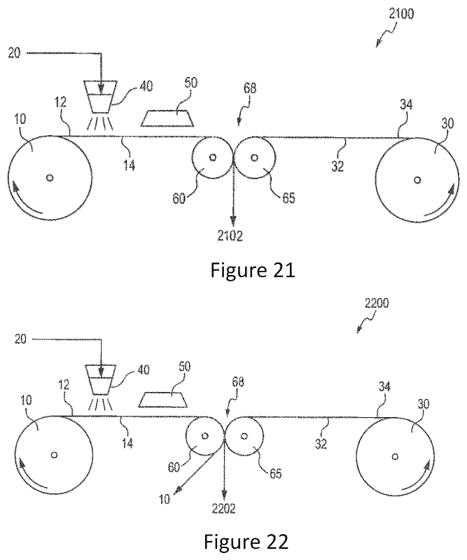

FIG. 21 schematically illustrates a system 2100 for forming an adhesive laminate in accordance with an embodiment described herein. It will be understood that the systems and methods described herein may also be used to produce laminates and coated face materials different than the embodiments described herein. The system 2100 and related process includes providing a supply of release liner 10 depicted in FIG. 21, for example in roll form. As will be understood, the release liner 10 includes a release face 12 and an oppositely directed outer face 14. The release face 12 includes a release material, release coating, and/or release agent such as described herein. The release liner 10 is directed towards a deposition system 40 at which a coating or adhesive composition 20 is applied to the release face 12 of the release liner 10. Typically, in many embodiments the coating or adhesive 20 is applied to the release liner 10 by spraying. However, other or particular spraying application techniques such as, but not limited to, ink jetting, electrospinning, airless spraying, air guided nozzle spraying, and the like, or combinations thereof, may also be used.

After receiving an effective amount of coating or adhesive deposited on the release face 12 of the release liner 10, the coating or adhesive containing release liner is optionally subjected to one or more curing operations depicted in FIG. 21 as curing station 50. The coating or adhesive may be partially or fully cured, crosslinked, or otherwise modified by the optional curing station 50. The curing station 50 may emit heat, radiation, and/or remove solvent(s) from the deposited coating or adhesive. In many instances, the curing results in an increase in viscosity of the coating or adhesive.

The adhesive containing release liner 10 is then directed to a roller assembly that includes a pair of rollers 60, 65 positioned and oriented for contacting and transferring the coating or adhesive. The rollers 60, 65 define a nip region 68 between the outer circumferential surfaces of the closely positioned rollers. The nip region is a region extending along a width or span of the rollers and encompasses the interface region between the rollers. FIG. 21 illustrates nip region 68 associated with the rollers 60, 65. The release liner 10 is directed to the first roller 60 and toward the nip region 68.

The system 2100 also contains a supply of face material 30 shown in FIG. 21 typically in roll form. The face material 30 includes an inner face 34 and an oppositely directed outer face 32. The face material 30 is directed to the roller assembly and specifically to the second roller 65 and toward the nip region 68.

Both the coating or adhesive containing release liner 10 and the face material 30 are concurrently passed between the rollers 60, 65 and within the nip region 68 such that the coating or adhesive 20 disposed on the release face 12 of the release liner 10 is at least partially contacted with the inner face 34 of the face material 30. The rollers 60, 65 are positioned and oriented relative to each other such that at least a portion of the coating or adhesive 20 is contacted with the inner face 34 of the face material 30. The resulting laminate 2102 exiting the rollers 60, 65 is then directed to a collecting station (not shown) which for example winds the laminate in roll form. It is also contemplated that the laminate may be subjected to one or other processing operations such as top coating with one or more protective films, die cutting to shape or form perforations, and/or receiving additional layers or components.

The coating or adhesive coated face materials described can also be formed by a transfer technique. In some embodiments, the release liner initially carrying the adhesive for transfer to the face material is removed or otherwise separated after such transfer. The release liner may be re-used or subsequently rejoined or incorporated with the coating or adhesive coated face material. FIG. 22 schematically illustrates a system and process for producing a coating or adhesive containing face material free of a release liner. The system 2200 is the same or similar as the system of FIG. 21, but after passing the liner 10, coating or adhesive 20, and face material 30 through the rollers 60, 65; the release liner 10 is separated from the face material 30 to produce a coating or adhesive containing face material 2202. As noted, the liner 10 could be redirected to the source roll 10, redirected for further processing, and/or rejoined with the coating or adhesive containing face material 2202.

Utilization of the techniques and features described herein enable production of coating or adhesive laminates and/or coating or adhesive coated face materials with fluid/air management characteristics, controlled removability, and/or unique thermal and/or electrical conductivity. In addition, use of these techniques and features enable reductions in materials, e.g., coatings or adhesives, and thus enable cost savings. However, it will be understood that the present subject matter includes the coating or adhesive coated face materials and laminates described herein which are formed by other methods than the methods described herein.

The methods of the present subject matter can be performed in a batch, continuous, or semi-continuous fashion. For continuous methods, typical processing speeds range from about 100 m/min to 1,000 m/min. However, it will be understood that the present subject matter is not limited to these speeds and includes processing speeds less than 100 m/min and/or speeds greater than 1,000 m/min.

The coating or adhesive laminates and/or adhesive coated face materials described herein can be prepared or manufactured using techniques for direct coating onto a face material and/or transfer coating of coating or adhesive from a release liner onto a face material. In one embodiment, the methods include depositing a coating or adhesive material onto a release liner, optionally curing or otherwise modifying the deposited coating or adhesive, and then concurrently passing the coating or adhesive coated release liner through rollers with a face material. As the adhesive on the release material is contacted with a face or region of the face material, at least a portion of the coating or adhesive is transferred to the face material. In many embodiments, the resulting laminate of face material, coating or adhesive, and release liner is collected and/or further processed. However, the present subject matter also includes methods in which after passing through the rollers, the release liner is separated and/or removed from the face material. Typically, at least a portion of the coating or adhesive remains with the face material. In other embodiments, the coating or adhesive may be directly coated onto the face material. In still other embodiments, at least a portion of the coating or adhesive may be coated onto an individually cut label or series of labels as an alternative to applying coating or adhesive, either by direct or transfer coating, onto a roll of facestock prior to formation of individual labels.

The methods described herein also includes applying or depositing the coating or adhesive on the release liner or onto the facestock in particular patterns and/or using particular techniques as described herein. In certain embodiments, the coating or adhesive can be applied by spraying in regular or ordered patterns on the release liner. Alternatively, in other embodiments, the adhesive or coating can be applied by spraying in irregular or random patterns. These patterns can be in dot form, in string form, filament, and wire form along with combinations thereof. Irregular or random patterns or patterning can overcome the limitations or problems associated with regular or uniform patterns or patterning including ungummed edges of the label which can result in poor dispensing, flagging, poor print quality, and/or poor die-cutting. In order to provide random and unique patterns turbulent air could be used while the adhesive or coating is applied. Combinations of these techniques can also be used. In certain configurations, multiple coating or adhesives may be deposited simultaneously, sequentially, or in a combination thereof. For example, a first coating or adhesive may be deposited from a first adhesive source and a second, different coating or adhesive may be deposited from a second adhesive source so as to form an intertwined pattern of the two coating or adhesives. Alternatively, or additionally, a first coating or patterned adhesive may be deposited directly onto a substrate followed by a coating or second, distinct adhesive may be deposited on top of the first coating or deposited adhesive. In still other configurations, a coating or first adhesive may be deposited in multiple lanes and a second, coating or distinct adhesive may be deposited in parallel lanes between the lanes of the coating or first adhesive. Of course, other configurations where a first coating or adhesive and second coating or adhesive are deposited on different areas of a substrate are also contemplated.

In some embodiments, the coating or adhesive is deposited on the release liner or face material such that one or more regions of the release face of the release liner or face material remain exposed. In some embodiments, the coverage of the release face or the face material by the coating or adhesive is less than 100%, less than 95%, less than 90%, less than 85%, less than 80%, less than 75%, less than 70%, less than 60%, less than 50%, less than 40%, and less than 30%. In some embodiments, the coating or adhesive coverage is at least 5%, at least 10%, and in particular embodiments at least 20%. In many embodiments, the coverage of coating or adhesive on the release liner or face material is within a range of from less than about 100% to about 5%, more particularly from about 95% to about 20%, and more particularly from about 60% to about 10%. In other embodiments, the percent coverage is from about 35% to about 70% or from about 40% to about 65%.

In some embodiments, upon directing such coating or adhesive containing release liners to a roller assembly at which the coating or adhesive is contacted with the face material, the extent of coverage of the face material by the coating or adhesive is the same or substantially the same as the coverage of the release face. For example, for an coating or adhesive containing release liner in which the coverage of the release face by adhesive is 70%, after roll to roll transfer to the face material, the coverage of coating or adhesive on the face material is also 70% or approximately 70%. In some embodiments, the coverage of coating or adhesive on a face material is within +10%, preferably +5% of the coverage by the coating or adhesive on the release liner. Non-limiting representative examples of coverage of coating or adhesive on a face material include from less than about 100% to about 5%, and typically within a range of from about 95% to about 20%. However, it will be appreciated that the present subject matter includes face materials having specific percentage coverages of about 75%, about 50%, or about 25%.

The present subject matter also includes adhesive laminates and/or coating or adhesive coated face materials that exhibit combinations of these aspects. In some embodiments, the coating or adhesive region(s) exhibit a thickness within a range of from about 20 mm to about 70 mm, a CDR within a range of from about 1 to about 10, and a coverage on a substrate within a range of from about 60% to about 10%.

In other embodiments, coating or adhesives are used which exhibit particular rheological characteristics. In some embodiments, the adhesives exhibit a viscosity within a range of from about 500 cPs to about 100,000 cPs at 150° C. In one embodiment, a coating or adhesive, which when heated to a temperature of 170° C., exhibits a viscosity of less than about 10,000 cPs, and which at ambient temperature will not flow at a pressure of 120 psi, has been found to be capable for forming a patterned coating or adhesive. In some embodiments, if a hot melt adhesive is used, the adhesive exhibits a viscosity within a range of from about 10,000 cPs to about 100,000 cPs at 150° C., preferably from about 30,000 cPs to about 50,000 cPs at 150° C. However, it will be understood that the present subject matter includes other coating or adhesives exhibiting viscosities outside of these ranges.

In some embodiments, the coating or adhesives are free of filler agents. In other embodiments, the adhesives may include filler agents. In some embodiments, fillers are particulate additives which can be added to adhesives to increase the bulk of the coating or adhesive and/or to improve properties. Fillers are commonly used in coating or adhesive formulations to: (1) reduce cost (e.g., addition of calcium carbonate, clay or talc); (2) color the coating or adhesives, for example, by the addition of titanium dioxide, colored toner and security tags; and (3) enhance performance such as by increasing stiffness and tensile strength, reducing cold flow, reducing edge flow, improved cutting, etc. Filler particles may be either inert-non-reinforcing fillers or active-reinforcing fillers. Inert-non-reinforcing fillers or extenders are fillers that do not strongly interact with the coating or potential adhesive polymer resin. Examples include, but are not limited to, untreated clay, talc, calcium carbonate and titanium dioxide. They are usually included in the coating or adhesive to increase adhesive bulk, reduce the cost, or change the appearance or chemical resistance of the adhesive. Such fillers also improve the handleability of the polymer resin mixture. The active-reinforcing fillers are those which interact with coating or the adhesive polymer resin by promoting, for example, additional cross-linking or filler-polymer interface interaction. Examples of such fillers include, but are not limited to, surface-treated clay, zinc oxide, fine particle size silica and carbon black. The reinforcement is usually defined in terms of an increase in mechanical properties such as tensile strength or modulus, and occasionally, adhesion properties.

Exemplary embodiments can further relate to removing at least one layer of the laminate in order to expose the coating or adhesive layer. This can be done through a laser cutter (not shown) or a cutting plotter (not shown). A laser cutter is a contactless cutting device and technique and any such situated cutter as known in the art is appropriate. Cutting plotters are known in the art as devices which can be used to mechanically cut graphics, lettering and a variety of shapes from a variety of materials such as paper, plastic, adhesive film.

Other exemplary embodiments provide for a layer with a coating or adhesive pattern adhered to the top of the laminate structure. In these embodiments, an optically isolated section of the face of the laminate can have one or more layers, including a top layer of a coating or adhesive can be applied. In other similar, but related, embodiments, a layer comprising NIR ink is deposited on the top of the laminate structure, and then the patterned coating or adhesive is applied to at least a portion of a top of this layer.

### Feature Deposition, Detection, and Extraction

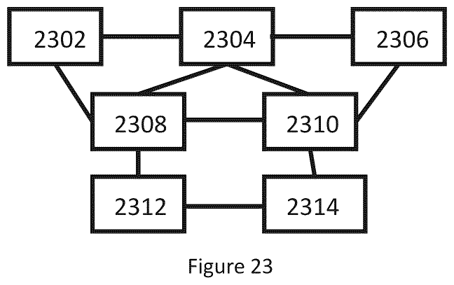

Additional embodiments are directed towards a system to image features a patterned coating on a laminate and store the image and its identified features. Specifically, the exemplary system is schematically shown in FIG. 23. An exemplary system 2300 can comprise, at least one detector 2302; at least one processor 2304; and at least one memory unit 2306; and wherein the at least one detector 2302 is operative to image a patterned coating on a laminate, the at least one processor 2304 is operative to identify features of the patterned coating, and the at least one memory unit 2306 is operative to store the image and its identified features. The system 2300 may further comprise at least one coating unit 2308 operative to deposit the patterned coating; at least one lamination unit 2310 operative to combine one or more layers of a laminate; and at least one ink unit 2312, wherein the ink unit is operative to deposit near-infrared (NIR) ink to the top of the laminate. Additionally, other embodiments can include a depositor unit 2314 that are operative to deposit the patterned coating. While in the exemplary figure different components are connected, this will be seen as exemplary and merely an example of how things could be physically coupled. In other embodiments (not shown) the connection may be electrically coupled or connected through wireless means in order to communicate information and/or data with other components and such illustration will not be seen as limiting.

The exemplary system 2300 can operate through passing the patterned coating laminate past the at least one detector 2302, where the at least one detector 2302 takes a measurement and this can be in the form of scale-invariant feature transform (SIFT) descriptors. These SIFT descriptors can then be processed and stored by a memory unit in a feature database. The SIFT descriptors can be for example, in the form of a vector of 128 floating points values that allows for features to be tracked and later matched by descriptors that are robust under varying viewing conditions and are not dependent on the features illumination or scale. In short, the image content is reduced to a set of points used to detect similar patterns in other images. Thus, the feature vector point is used to extract serialization information and create a digital identification for the laminate with the coating or adhesive pattern deposited thereon.

Exemplary embodiments are also directed towards a method comprising: processing a provided image of a patterned coating on a laminate; analyzing the provided image against a database of recorded coating patterns; matching the provided image with an entry in the database; and providing a response corresponding to the entry. This embodiment, or another exemplary embodiment can be when the laminate is multilayered, the patterned coating is longitudinally under at least one layer of the laminate. Alternatively, the patterned coating is located on top of the laminate. In the exemplary embodiment the pattern of the coating is discontinuous and irregular and the pattern of the coating has a coverage over the area of at least one layer of the laminate greater than about 5% and less than about 75%.

All definitions, as defined and used herein, should be understood to control over dictionary definitions, definitions in documents incorporated by reference, and/or ordinary meanings of the defined terms.

The articles “a” and “an,” as used herein in the specification and in the claims, unless clearly indicated to the contrary, should be understood to mean “at least one.” The phrase “and/or,” as used herein in the specification and in the claims (if at all), should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc. As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

An embodiment is an implementation or example of the present disclosure. Reference in the specification to “an embodiment,” “one embodiment,” “some embodiments,” “one particular embodiment,” or “other embodiments,” or the like, means that a particular feature, structure, or characteristic described in connection with the embodiments is included in at least some embodiments, but not necessarily all embodiments, of the invention. The various appearances “an embodiment,” “one embodiment,” “some embodiments,” “one particular embodiment,” or “other embodiments,” or the like, are not necessarily all referring to the same embodiments.

If this specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0. % of the stated value (or range of values), +/−1% of the stated value (or range of values), +/−2% of the stated value (or range of values), +/−5% of the stated value (or range of values), +/−10% of the stated value (or range of values), etc. Any numerical range recited herein is intended to include all sub-ranges subsumed therein.

Additionally, any method of performing the present disclosure may occur in a sequence different than those described herein. Accordingly, no sequence of the method should be read as a limitation unless explicitly stated. It is recognizable that performing some of the steps of the method in a different order could achieve a similar result.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures.

In the foregoing description, certain terms have been used for brevity, clarity, and understanding. No unnecessary limitations are to be implied therefrom beyond the requirement of the prior art because such terms are used for descriptive purposes and are intended to be broadly construed.

Moreover, the description and illustration of various embodiments of the disclosure are examples and the disclosure is not limited to the exact details shown or described.

1. A method comprising:
applying a coating in a pattern to at least one component of a laminate;
exposing the coating pattern;
recording the pattern of the coating; and
creating a data bearing record containing the pattern of the coating.

2. The method of claim 1, further comprising:
providing a release liner defining a release face and an oppositely directed outer face.

3. The method of claim 2 further comprising:
providing a face material defining an inner face and an oppositely directed outer face; and
concurrently passing both the coating containing release liner and the face material through a nip region defined between at least one roller of a roller assembly, wherein at least a portion of the coating is contacted with the inner face of the face material to thereby form the laminate.

4. The method of claim 1, wherein the pattern of the coating is discontinuous and irregular.

5. The method of claim 1, wherein the pattern of the coating has a coverage over the area of the component of the laminate greater than about 5% and less than about 75%.

6. The method of claim 1, wherein the coating is applied via spray coating.

7. The method of claim 1, further comprising:
laminating an optically transparent layer over the coating pattern.

8. The method of claim 1, wherein the applying of the coating is done on top of a laminate structure.

9. The method of claim 1, further comprising,
laminating a layer comprising near-infrared (NIR) ink to the top of the laminate structure, and applying the patterned coating to at least a portion of a top of this layer.

10. The method of claim 1, wherein the exposing step comprises:
removing at least a portion of at least one layer of the laminate.

11. A method comprising:
processing a provided image of a patterned coating on a laminate;
analyzing the provided image against a database of recorded coating patterns;
matching the provided image with an entry in the database; and
providing a response corresponding to the entry.

12. The method of claim 11, wherein the laminate is multilayered, and the patterned coating is longitudinally under at least one layer of the laminate.

13. The method of claim 11, wherein the patterned coating is located on top of the laminate.

14. The method of claim 11, wherein the pattern of the coating is discontinuous and irregular.

15. The method of claim 11, wherein the pattern of the coating has a coverage over the area of at least one layer of the laminate greater than about 5% and less than about 75%.

16. A system comprising:
at least one detector;
at least one processor; and
at least one memory unit; and
wherein the at least one detector is operative to image a patterned coating on a laminate, the at least one processor is operative to identify features of the patterned coating, and the at least one memory unit is operative to store the image and its identified features.

17. The system of claim 16, wherein the patterned coating is applied via spray coating.

18. The system of claim 16, further comprising:
at least one coating unit operative to deposit the patterned coating; and
at least one lamination unit operative to combine one or more layers of a laminate.

19. The system of claim 16, further comprising:
at least one ink unit, wherein the ink unit is operative to deposit near-infrared (NIR) ink to the top of the laminate.

20. The system of claim 16, wherein the pattern of the coating is discontinuous and irregular.
